(19) United States
(12) Patent Application Publication
(10) Pub. No.: US 2025/0321376 A1
(43) Pub. Date: Oct. 16, 2025

(54) MULTICORE FIBER CONNECTOR, OPTICAL COMMUNICATION NETWORK USING MULTICORE FIBER CONNECTOR, AND METHOD FOR CONNECTING OPTICAL COMMUNICATION NETWORK

(71) Applicant: Fujikura Ltd., Tokyo (JP)

(72) Inventor: Takuya Oda, Sakura-shi (JP)

(73) Assignee: Fujikura Ltd., Tokyo (JP)

(21) Appl. No.: 18/867,843

(22) PCT Filed: Feb. 16, 2023
(86) PCT No.: PCT/JP2023/005399

§ 371 Date: Nov. 21, 2024

(30) Foreign Application Priority Data
Jun. 8, 2022 (JP) 2022-093340

(51) Int. Cl. G02B 6/24; H04B 10/25; H04B 10/27; H04J 14/00

(52) U.S. Cl. CPC G02B 6/24; H04B 10/25; H04B 10/27; H04J 14/00

(57) ABSTRACT

An optical communication network includes: nodes; and a domain in which all of transmission paths that connect the nodes within the domain are constituted by multi-core fiber connected bodies, each of which includes one or more multi-core fibers and one or more pairs of Fan-In/Fan-Out (FI/FO) devices respectively connected to ends of a corresponding one of the one or more multi-core fibers. Each pair of the one or more pairs of FI/FO devices connected to ends of the corresponding one of the one or more multi-core fibers has a reversely symmetrical coupling structure. Each of the one or more pairs of FI/FO devices includes ports identifiable from each other and coupled with respective cores of the one or more multi-core fibers.

### TECHNICAL FIELD

The present invention relates to an optical communication network using a multi-core fiber and a method for manufacturing such an optical communication network. Further, the present invention relates to a multi-core fiber connected body in which paired FI/FO devices are connected to both ends of a multi-core fiber.

### BACKGROUND

In the field of optical communications, a multi-core fiber including a plurality of cores is widely used. A document disclosing the multi-core fiber is, for example, Patent Literature 1.

### PATENT LITERATURE

### Patent Literature 1

Japanese Patent Application Publication, Tokukai, No. 2019-152866

The inventors of the present application found that using a multi-core fiber as a transmission path of an optical communication network may raise the following issues.

To both ends of the multi-core fiber, Fan-In/Fan-Out (FI/FO) devices are connected in many cases. Multi-core fiber connected bodies obtained by connecting FI/FO devices to both ends of a multi-core fiber include a normal-type fiber connected body Cs in which the FI/FO devices at both ends thereof have reversely symmetrical coupling structures and a reverse-type fiber connected body Cc in which the FI/FO devices at both ends thereof have congruent coupling structures.

Using such a multi-core fiber connected body as a transmission path of an optical communication network may raise the following issues.

That is, assume a case where after a FI/FO device at one end of the multi-core fiber connected body has been connected to a first node, a FI/FO device at the other end of the multi-core fiber connected body is connected to a second node. In this case, an operator who connects the FI/FO device at the other end of the multi-core fiber connected body to the second node needs to have two pieces of knowledge. The first one is knowledge on to which ports of the first node the respective ports of the FI/FO device at the one end of the multi-core fiber connected body are connected. The second one is knowledge on whether the multi-core fiber connected body is a normal-type multi-core fiber connected body or a reverse-type multi-core fiber connected body. This is because the ports of the second node to which the respective ports of the FI/FO device at the other end of the multi-core fiber connected body are to be connected differ depending on these pieces of knowledge.

For example, on the assumption that a normal-type multi-core fiber connected body is used as a multi-core fiber connected body C, in a case where a port P1 of the FI/FO device at one end thereof is connected to a transmission port Tx1, a port P1 of the FI/FO device at the other end thereof needs to be connected to the reception port Rx1, as illustrated in (a) of FIG. 21. In contrast, on the assumption that a reverse-type multi-core fiber connected body is used as the multi-core fiber connected body, in a case where a port P1 of the FI/FO device at one end thereof is connected to a transmission port Tx1, a port P2 of the FI/FO device at the other end thereof needs to be connected to the reception port Rx1, as illustrated in (b) of FIG. 21.

As described above, in a case where a multi-core fiber connected body is used as a transmission path of an optical communication network, an operator needs to have the two pieces of knowledge described above for an operation of connecting the multi-core fiber connected body to a node. This is why it has been difficult to construct or design an optical communication network including a multi-core fiber connected body as a transmission path or to increase or decrease the number of nodes.

### SUMMARY

One or more embodiments of the present invention achieve an optical communication network, a multi-core fiber connected body, or a method for manufacturing an optical communication network, each of in which it is easy to construct or design the optical communication network or to perform a connection operation for increasing or decreasing the number of nodes.

An optical communication network in accordance with one or more embodiments of the present invention is an optical communication network including a plurality of nodes, the optical communication network including (1) a domain in which all of a plurality of transmission paths that connect nodes within the domain are constituted by multi-core fiber connected bodies each of which includes one or more multi-core fibers and paired FI/FO devices connected to both ends of the one or more multi-core fibers and having reversely symmetrical coupling structures or (2) a domain in which all of a plurality of transmission paths that connect nodes within the domain are constituted by multi-core fiber connected bodies each of which includes one or more multi-core fibers and paired FI/FO devices connected to both ends of the one or more multi-core fibers and having congruent coupling structures, the paired FI/FO devices each having ports identifiable from each other, the ports being coupled with respective cores of the one or more multi-core fibers.

A multi-core fiber connected body in accordance with one or more embodiments of the present invention includes: one or more multi-core fibers; and paired FI/FO devices connected to both ends of the one or more multi-core fibers, the paired FI/FO devices having reversely symmetrical coupling structures or having congruent coupling structures, the paired FI/FO devices each having ports identifiable from each other, the ports being coupled with respective cores of the one or more multi-core fibers.

A method for manufacturing an optical communication network, in accordance with one or more embodiments of the present invention is a method for manufacturing an optical communication network including a plurality of nodes, the method including the step of, as all of a plurality of transmission paths connecting nodes in a specific domain, (1) selecting multi-core fiber connected bodies each of which includes a multi-core fiber and paired FI/FO devices connected to both ends of the multi-core fiber and having reversely symmetrical coupling structures or (2) selecting multi-core fiber connected bodies each of which includes a multi-core fiber and paired FI/FO devices connected to both ends of the multi-core fiber and having congruent coupling structures, the paired FI/FO devices each having ports identifiable from each other, the ports being coupled with cores of the multi-core fiber.

According to one or more embodiments of the present invention, it is possible to achieve an optical communication network in which it is easy to construct or design the optical communication network or to perform a connection operation for increasing or decreasing the number of nodes.

### BRIEF DESCRIPTION OF THE DRAWINGS

FIG. 1 is a view illustrating a multi-core fiber used in each of embodiments of the present invention. In FIG. 1, (a) is a side view illustrating the multi-core fiber, (b) is a front view illustrating one end surface of the multi-core fiber, and (c) is a front view illustrating the other end surface of the multi-core fiber.

FIG. 2 is a view schematically illustrating a normal-type multi-core fiber connected body used in Embodiment 1 of the present invention.

FIG. 3 is a view schematically illustrating a reverse-type multi-core fiber connected body used in Embodiment 2 of the present invention.

FIG. 4 is a block diagram illustrating a first specific example of an optical communication network in accordance with Embodiment 1 of the present invention.

FIG. 5 is a block diagram illustrating a second specific example of the optical communication network in accordance with Embodiment 1 of the present invention.

FIG. 6 is a block diagram illustrating a third specific example of the optical communication network in accordance with Embodiment 1 of the present invention.

FIG. 7 is a block diagram illustrating a fourth specific example of the optical communication network in accordance with Embodiment 1 of the present invention.

FIG. 8 is a block diagram illustrating a fifth specific example of the optical communication network in accordance with Embodiment 1 of the present invention.

FIG. 9 is a block diagram illustrating a sixth specific example of the optical communication network in accordance with Embodiment 1 of the present invention.

FIG. 10 is a block diagram illustrating a seventh specific example of the optical communication network in accordance with Embodiment 1 of the present invention.

FIG. 11 is a block diagram illustrating an eighth specific example of the optical communication network in accordance with Embodiment 1 of the present invention.

FIG. 12 is a block diagram illustrating a first specific example of an optical communication network in accordance with Embodiment 2 of the present invention.

FIG. 13 is a block diagram illustrating a second specific example of the optical communication network in accordance with Embodiment 2 of the present invention.

FIG. 14 is a block diagram illustrating a third specific example of the optical communication network in accordance with Embodiment 2 of the present invention.

FIG. 15 is a block diagram illustrating a fourth specific example of the optical communication network in accordance with Embodiment 2 of the present invention.

FIG. 16 is a block diagram illustrating a fifth specific example of the optical communication network in accordance with Embodiment 2 of the present invention.

FIG. 17 is a block diagram illustrating a sixth specific example of the optical communication network in accordance with Embodiment 2 of the present invention.

FIG. 18 is a block diagram illustrating a seventh specific example of the optical communication network in accordance with Embodiment 2 of the present invention.

FIG. 19 is a block diagram illustrating an eighth specific example of the optical communication network in accordance with Embodiment 2 of the present invention.

(a) of FIG. 20 is a view schematically illustrating a configuration of a typical multi-core fiber, (b) of FIG. 20 is a view schematically illustrating how the multi-core fiber illustrated in (a) is normally connected, and (c) of FIG. 20 is a view schematically illustrating how the multi-core fiber illustrated in (a) is reversely connected.

(a) of FIG. 21 is a view schematically illustrating a configuration of a typical normal-type multi-core fiber connected body, and (b) of FIG. 21 is a view schematically illustrating a configuration of a typical reverse-type multi-core fiber connected body.

### DETAILED DESCRIPTION

The inventors of the present application considered using a multi-core fiber as a transmission path of an optical communication network in order to satisfy a need for increasing a capacity of the optical communication network. During the consideration, the inventors of the present application found that using a multi-core fiber as a transmission path of the optical communication network may raise the following issues.

An example of a multi-core fiber is illustrated in (a) of FIG. 20. The multi-core fiber MF illustrated in (a) of FIG. 20 includes four cores a1 to a4 and one marker c. The cores a1 to a4 are arranged so as to be axisymmetric with respect to a straight line L1 on each of the end surfaces σ1 and σ2. The center of the marker c is arranged so as to be located in a position other than the straight line L1 on each of the end surfaces σ1 and σ2. This makes it possible to identify the cores a1 to a4 with reference to the marker c. The core a1 is the core closest to the marker c, the core a2 is the core second closest to the marker c, the core a3 is the core third closest to the marker c, and the core a4 is the core farthest from the marker c. Note that the center of the marker c may be disposed on the straight line L1 on each of the end surfaces σ1 and σ2. In a case where the cores are identified on each of the end surfaces σ1 and σ2 in view of a configuration other than a marker, for example, in a case where the cores are identified on each of the end surfaces σ1 and σ2 by emitting light into the cores, the marker c can be omitted.

To both ends of the multi-core fiber, Fan-In/Fan-Out (FI/FO) devices are connected in many cases. The FI/FO device is configured to have a plurality of identifiable ports capable of being coupled with the respective plurality of cores of a multi-core fiber. In a case where these ports are connected to respective single-core fibers, for example, labels attached to the single-core fibers enable the ports to be identified. In a case where these ports are connected to single-core fibers bundled as a tape core wire or a ribbon fiber, positions of the single-core fibers in the ribbon fiber enable the ports to be identified. In a case where these ports are terminated by a multi-core connector, the positions of the multi-core connector to which the respective ports are connected enable the ports to be identified. Multi-core fiber connected bodies obtained by connecting FI/FO devices to both ends of a multi-core fiber include a normal-type fiber connected body Cs in which the FI/FO devices at both ends thereof have reversely symmetrical coupling structures and a reverse-type fiber connected body Cc in which the FI/FO devices at both ends thereof have congruent coupling structures.

(b) of FIG. 20 is a view schematically illustrating a normal-type multi-core fiber connected body Cs in which two FI/FO devices τ1 and τ2 having reversely symmetrical coupling structures are connected to both ends σ1 and σ2 of the multi-core fiber MF illustrated in (a) of FIG. 20. The FI/FO device τ1 connected to the end surface σ1 of the multi-core fiber MF is configured to (1) couple a first port P1 thereof with the core a1 located at the upper left on the end surface σ1, (2) couple a second port P2 thereof with the core a2 located at the upper right on the end surface σ1, (3) couple a third port P3 thereof with the core a3 located at the lower left on the end surface σ1, and (4) couple a fourth port P4 thereof with the core a4 located at the lower right on the end surface σ1. The FI/FO device τ2 connected to the end surface σ2 of the multi-core fiber MF is configured to (1) couple a second port P2 thereof with the core a2 located at the upper left on the end surface σ2, (2) couple a first port P1 thereof with the core a1 located at the upper right on the end surface σ2, (3) couple a fourth port P4 thereof with the core a4 located at the lower left on the end surface σ2, and (4) couple a third port P3 thereof with the core a3 located at the lower right on the end surface σ2. Therefore, (1) the first port P1 of the one FI/FO device τ1 is coupled with the first port P1 of the other FI/FO device τ2, (2) the second port P2 of the one FI/FO device τ1 is coupled with the second port P2 of the other FI/FO device τ2, (3) the third port P3 of the one FI/FO device τ1 is coupled with the third port P3 of the other FI/FO device τ2, and (4) the fourth port P4 of the one FI/FO device τ1 is coupled with the fourth port P4 of the other FI/FO device τ2.

Note that (b) of FIG. 20 shows, as an example of a normal-type multi-core fiber connected body, a multi-core fiber connected body Cs in which the FI/FO device τ1 is connected to the one end surface σ1 of the multi-core fiber MF and the FI/FO device τ2 is connected to the other end surface σ2 of the multi-core fiber MF, but this should not be construed as a limitation. For example, another example of the normal-type multi-core fiber connected body may be a multi-core fiber connected body in which the FI/FO device τ2 is connected to the one end surface σ1 of the multi-core fiber MF and the FI/FO device τ1 is connected to the other end surface σ2 of the multi-core fiber MF.

(c) of FIG. 20 is a view schematically illustrating a reverse-type multi-core fiber connected body Cc in which two FI/FO devices 11 having congruent coupling structures are connected to the both ends σ1 and σ2 of the multi-core fiber MF illustrated in (a) of FIG. 20. The FI/FO device τ1 connected to the end surface σ1 of the multi-core fiber MF is configured to (1) couple the first port P1 thereof with the core a1 located at the upper left on the end surface σ1, (2) couple the second port P2 thereof with the core a2 located at the upper right on the end surface σ1, (3) couple the third port P3 thereof with the core a3 located at the lower left on the end surface σ1, and (4) couple the fourth port P4 thereof with the core a4 located at the lower right on the end surface σ1. The FI/FO device τ1 connected to the end surface σ2 of the multi-core fiber MF is configured to (1) couple the first port P1 thereof with the core a2 located at the upper left on the end surface σ2, (2) couple the second port P2 thereof with the core a1 located at the upper right on the end surface σ2, (3) couple the third port P3 thereof with the core a4 located at the lower left on the end surface σ2, and (4) couple the fourth port P4 thereof with the core a3 located at the lower right on the end surface σ2. Therefore, (1) the first port P1 of the one FI/FO device τ1 is coupled with the second port P2 of the other FI/FO device τ1, (2) the second port P2 of the one FI/FO device τ1 is coupled with the first port P1 of the other FI/FO device τ1, (3) the third port P3 of the one FI/FO device τ1 is coupled with the fourth port P4 of the other FI/FO device τ1, and (4) the fourth port P4 of the one FI/FO device 11 is coupled with the third port P3 of the other FI/FO device T1.

Note that (c) of FIG. 20 shows, as an example of a reverse-type multi-core fiber connected body, the multi-core fiber connected body Cc in which the FI/FO devices τ1 are connected to the both end surfaces σ1 and σ2 of the multi-core fiber MF, but this should not be construed as a limitation. For example, another example of the reverse-type multi-core fiber connected body may be a multi-core fiber connected body in which the FI/FO devices τ2 are connected to the both end surfaces σ1 and σ2 of the multi-core fiber MF.

Using such a multi-core fiber connected body as a transmission path of an optical communication network may raise the following issues.

Assume a case where after the FI/FO device T1 at one end of the multi-core fiber connected body C has been connected to a first node N1, the FI/FO device T2 at the other end of the multi-core fiber connected body C is connected to a second node N2. In this case, an operator who connects the FI/FO device T2 at the other end of the multi-core fiber connected body C to the second node N2 needs to have two pieces of knowledge. The first one is knowledge on to which ports of the first node N1 the respective ports P1 to P4 of the FI/FO device T1 at the one end of the multi-core fiber connected body C are connected. The second one is knowledge on whether the multi-core fiber connected body C is a normal-type multi-core fiber connected body Cs or a reverse-type multi-core fiber connected body Cc. This is because the ports of the second node N2 to which the respective ports P1 to P4 of the FI/FO device T at the other end of the multi-core fiber connected body C are to be connected differ depending on these pieces of knowledge.

For example, on the assumption that a normal-type multi-core fiber connected body Cs in which the FI/FO devices T1 and T2 at the both ends thereof have reversely symmetrical coupling structures is used as the multi-core fiber connected body C, in a case where the port P1 of the FI/FO device T1 at one end thereof is connected to a transmission port Tx1, the port P1 of the FI/FO device T2 at the other end thereof needs to be connected to the reception port Rx1, as illustrated in (a) of FIG. 21. In contrast, on the assumption that a reverse-type multi-core fiber connected body Cc in which the FI/FO devices T1 and T2 at the both ends thereof have congruent coupling structures is used as the multi-core fiber connected body C, in a case where the port P1 of the FI/FO device T1 at one end thereof is connected to the transmission port Tx1, the port P2 of the FI/FO device T2 at the other end thereof needs to be connected to the reception port Rx1, as illustrated in (b) of FIG. 21.

As described above, in a case where a multi-core fiber connected body is used as a transmission path of an optical communication network, an operator needs to have the two pieces of knowledge described above for an operation of connecting the multi-core fiber connected body to a node. This is why it has been difficult to construct or design an optical communication network including a multi-core fiber connected body as a transmission path or to increase or decrease the number of nodes. One or more embodiments eliminate the need for the second knowledge described above, i.e., knowledge on whether the FI/FO devices at the both ends have reversely symmetrical coupling structures or congruent coupling structures and thus to facilitate these operations.

### [Multi-Core Fiber]

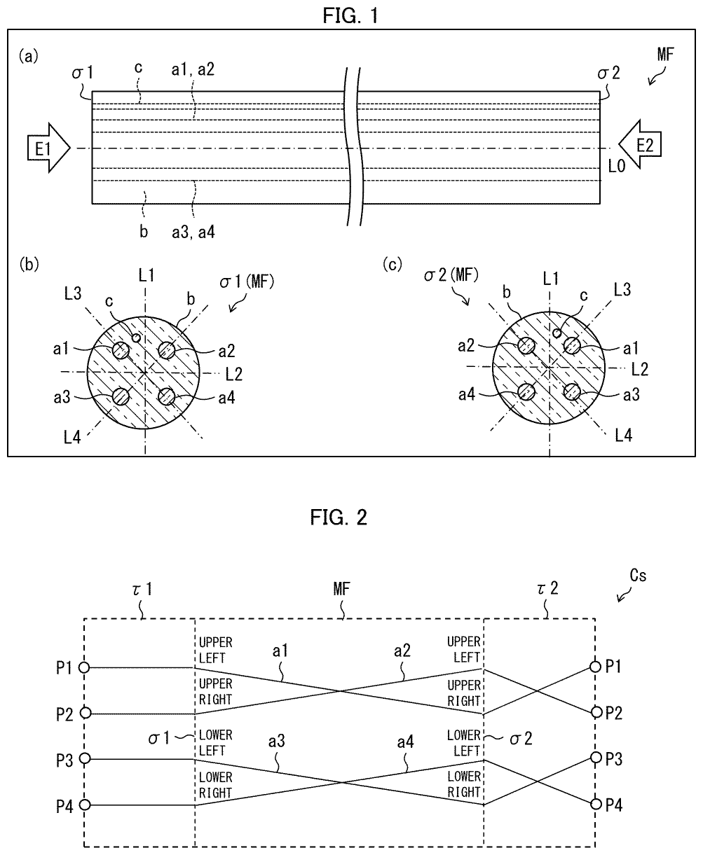

With reference to FIG. 1, the following description will discuss the multi-core fiber MF used in each of the embodiments of the present invention. In FIG. 1, (a) is a side view illustrating the multi-core fiber MF, (b) is a front view illustrating one end surface σ1 of the multi-core fiber MF viewed in a direction of a sight line E1, and (c) is a front view illustrating the other end surface σ2 of the multi-core fiber MF viewed in a direction of a sight line E2.

The multi-core fiber MF includes n (n is a natural number of not less than two) cores a1 to an and a cladding b. The cladding b is a cylindrical member. The cladding b is made of silica glass, for example. Each core ai (i is a natural number of not less than one and not more than n) is a cylindrical-shape area that resides inside the cladding b, that has a higher refractive index than that of the cladding b, and that extends in a direction in which the cladding b extends. Each core ai is made of, for example, silica glass doped with an updopant such as germanium. The cladding b only needs to be a columnar shape, and may have any cross-sectional shape. The cross-sectional shape of the cladding b may be a polygonal shape such as a quadrangular shape or a hexagonal shape or may be a barrel shape. The above description discusses the case where the above multi-core fiber MF is a single fiber. However, the multi-core fiber MF may include two or more fibers.

On each of the end surfaces σ1 and σ2, the cores a1 to an are arranged so as to be axisymmetric with respect to the axis L1 which is orthogonal to a central axis L0 of the multi-core fiber MF.

The multi-core fiber MF further includes a marker c. The marker c is a columnar area that resides inside the cladding b, that has a different refractive index from that of the cladding b, and that extends in a direction in which the cladding b extends. The cross-sectional shape of the marker c may be any shape. For example, the cross-sectional shape of the marker c may be a circular shape, a triangular shape, or a quadrangular shape. The marker c is made of, for example, silica glass doped with a downdopant such as fluorine or boron. In this case, the marker c has a refractive index lower than that of the cladding b. Alternatively, the marker c is made of silica glass doped with an updopant such as germanium, aluminum, phosphorus, or chlorine. In this case, the marker c has a refractive index higher than that of the cladding b. The marker c may be formed by, for example, a drilling process or a stack-and-draw process. The outer diameter of the marker c is usually smaller than the outer diameter of the core ai. In a case where the identification of the cores on the end surfaces σ1 and σ2 is optically carried out, the marker c can be omitted.

On each of the end surfaces σ1 and σ2, a center of the marker c is positioned so as to avoid the axis L1. In other words, on each of the end surfaces σ1 and σ2, the center of the marker c is positioned at a location that does not overlap the axis L1. Note that the position of the marker c only needs to be defined so that the center of the marker c can avoid the axis L1. The marker c may partially overlap the axis L1. This makes it possible to uniquely identify the cores a1 to a4 on the end surfaces σ1 and σ2. In the example illustrated in FIG. 1, the core closest to the marker c is the core a1, the core second closest to the marker c is the core a2, the core third closest to the marker c is the core a3, and the core farthest from the marker c is the core a4.

Note that the cores a1 to a4 of the multi-core fiber MF illustrated in FIG. 1 can be regarded as being disposed so as to be axisymmetric with respect to an axis L2, or can also be regarded as being arranged so as to be axisymmetric with respect to an axis L3, or can also be regarded as arranged so as to be axisymmetric with respect to an axis L4. Here, the axis L2 is an axis orthogonal to both the central axis L0 and the axis L1. The axes L3 and L4 are each an axis that is orthogonal to the central axis L0 and that has an angle of 45 degrees with the axis L1.

### [Multi-Core Fiber Connected Body]

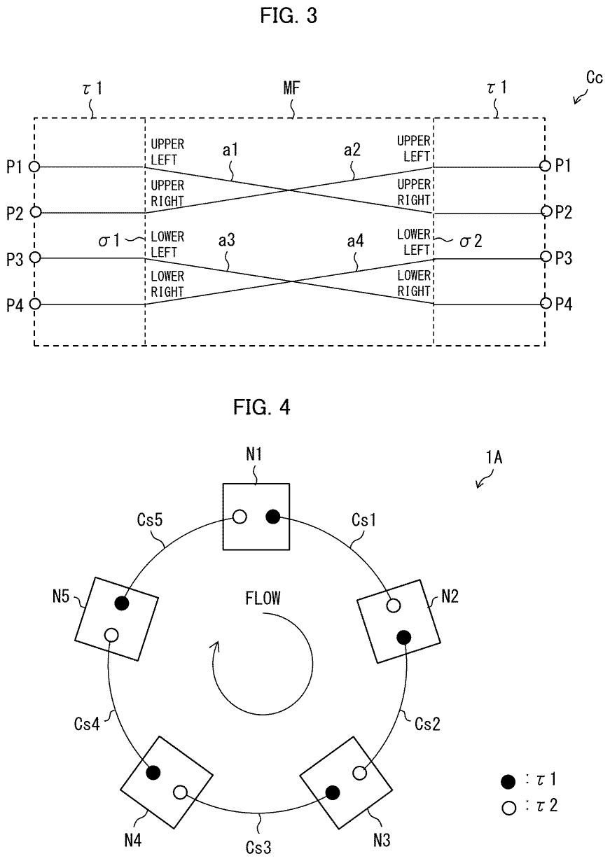

With reference to FIGS. 2 and 3, the following description will discuss the multi-core fiber connected body Cs used in Embodiment 1 of the present invention and the multi-core fiber connected body Cc used in Embodiment 2 of the present invention.

FIG. 2 is a view schematically illustrating the normal-type multi-core fiber connected body Cs. The normal-type multi-core fiber connected body Cs includes the multi-core fiber MF and the paired FI/FO devices 11 and τ2 connected to the both ends σ1 and σ2 of the multi-core fiber MF and having reversely symmetrical coupling structures. The FI/FO device τ1 connected to the end surface σ1 of the multi-core fiber MF is configured to (1) couple the first port P1 thereof with the core a1 located at the upper left on the end surface σ1, (2) couple the second port P2 thereof with the core a2 located at the upper right on the end surface σ1, (3) couple the third port P3 thereof with the core a3 located at the lower left on the end surface σ1, and (4) couple the fourth port P4 thereof with the core a4 located at the lower right on the end surface σ1. The FI/FO device τ2 connected to the end surface σ2 of the multi-core fiber MF is configured to (1) couple the second port P2 thereof with the core a2 located at the upper left on the end surface σ2, (2) couple the first port P1 thereof with the core a1 located at the upper right on the end surface σ2, (3) couple the fourth port P4 thereof with the core a4 located at the lower left on the end surface σ2, and (4) couple the third port P3 thereof with the core a3 located at the lower right on the end surface σ2. Therefore, (1) the first port P1 of the one FI/FO device τ1 is coupled with the first port P1 of the other FI/FO device τ2, (2) the second port P2 of the one FI/FO device τ1 is coupled with the second port P2 of the other FI/FO device τ2, (3) the third port P3 of the one FI/FO device τ1 is coupled with the third port P3 of the other FI/FO device τ2, and (4) the fourth port P4 of the one FI/FO device τ1 is coupled with the fourth port P4 of the other FI/FO device τ2.

Note that FIG. 2 shows, as an example of the normal-type multi-core fiber connected body, the multi-core fiber connected body Cs in which the FI/FO device τ1 is connected to the one end surface σ1 of the multi-core fiber MF and the FI/FO device τ2 is connected to the other end surface σ2 of the multi-core fiber MF, but this should not be construed as a limitation. For example, another example of the normal-type multi-core fiber connected body may be a multi-core fiber connected body in which the FI/FO device τ2 is connected to the one end surface σ1 of the multi-core fiber MF and the FI/FO device τ1 is connected to the other end surface σ2 of the multi-core fiber MF.

The multi-core fiber MF of the normal-type multi-core fiber connected body Cs may be a single multi-core fiber molded integrally or may be a multi-core fiber connected body in which a plurality of multi-core fibers each integrally molded are connected.

The FI/FO devices τ1 and τ2 may be fiber bundle type FI/FO devices, melt-stretching type FI/FO devices, spatial optical type FI/FO devices, or planar waveguide type FI/FO devices.

FIG. 3 is a view schematically illustrating the reverse-type multi-core fiber connected body Cc. The multi-core fiber connected body Cc includes the multi-core fiber MF and the paired FI/FO devices τ1 and τ1 connected to the both ends σ1 and σ2 of the multi-core fiber MF and having congruent coupling structures. The FI/FO device τ1 connected to the end surface σ1 of the multi-core fiber MF is configured to (1) couple the first port P1 thereof with the core a1 located at the upper left on the end surface σ1, (2) couple the second port P2 thereof with the core a2 located at the upper right on the end surface σ1, (3) couple the third port P3 thereof with the core a3 located at the lower left on the end surface σ1, and (4) couple the fourth port P4 thereof with the core a4 located at the lower right on the end surface σ1. The FI/FO device τ1 connected to the end surface σ2 of the multi-core fiber MF is configured to (1) couple the first port P1 thereof with the core a2 located at the upper left on the end surface σ2, (2) couple the second port P2 thereof with the core a1 located at the upper right on the end surface σ2, (3) couple the third port P3 thereof with the core a4 located at the lower left on the end surface σ2, and (4) couple the fourth port P4 thereof with the core a3 located at the lower right on the end surface σ2. Therefore, (1) the first port P1 of the one FI/FO device τ1 is coupled with the second port P2 of the other FI/FO device τ1, (2) the second port P2 of the one FI/FO device τ1 is coupled with the first port P1 of the other FI/FO device τ1, (3) the third port P3 of the one FI/FO device τ1 is coupled with the fourth port P4 of the other FI/FO device 11, and (4) the fourth port P4 of the one FI/FO device τ1 is coupled with the third port P3 of the other FI/FO device τ1.

Note that FIG. 3 shows, as an example of a reverse-type multi-core fiber connected body, the multi-core fiber connected body Cc in which the FI/FO devices τ1 are connected to the both end surfaces σ1 and σ2 of the multi-core fiber MF, but this should not be construed as a limitation. For example, another example of the reverse-type multi-core fiber connected body may be a multi-core fiber connected body in which the FI/FO devices τ2 are connected to the both end surfaces σ1 and σ2 of the multi-core fiber MF

The multi-core fiber MF of the reverse-type multi-core fiber connected body Cc may be a single multi-core fiber molded integrally or may be a multi-core fiber in which a plurality of multi-core fibers each integrally molded are connected.

The FI/FO devices τ1 and τ2 may be fiber bundle type FI/FO devices, melt-stretching type FI/FO devices, spatial optical type FI/FO devices, or planar waveguide type FI/FO devices. Further, to the above-described ports of the FI/FO devices τ1 and τ2, either one or both of the multi-core fiber and the single-core fiber may or may not be connected. The FI/FO devices τ1 and τ2 may be each constituted by one or more device body portions in which neither the multi-core fiber nor the single-core fiber are connected to the above-described ports.

### Embodiment 1

With reference to FIGS. 4 to 11, the following description will discuss optical communication networks 1A to 1H in accordance with Embodiment 1 of the present invention. The optical communication networks 1A to 1H in accordance with the embodiment are each an optical communication network including a plurality of nodes and including a domain in which all of a plurality of transmission paths that connect nodes within the domain are constituted by multi-core fiber connected bodies (normal-type multi-core fiber connected bodies) in each of which FI/FO devices having reversely symmetrical coupling structures are connected to both ends of a multi-core fiber.

### First Specific Example

With reference to FIG. 4, the following description will discuss a first specific example of an optical communication network in accordance with the embodiment (hereinafter, referred to as “optical communication network 1A”).

The optical communication network 1A in accordance with the present specific example includes a plurality of nodes N1 to N5 and a plurality of multi-core fiber connected bodies Cs1 to Cs5 connecting the nodes. The nodes N1 to N5 and the multi-core fiber connected bodies Cs1 to Cs5 constitute a ring-type network. Each of the multi-core fiber connected bodies Cs1 to Cs5 is a normal-type multi-core fiber connected body.

A characteristic of the optical communication network 1A is that all of the transmission paths thereof connecting the nodes are constituted by normal-type multi-core fiber connected bodies, that is, multi-core fiber connected bodies in each of which the FI/FO devices having reversely symmetrical coupling structures are connected to the both ends of the multi-core fiber.

This enables an operator who connects one end of the multi-core fiber connected body to a node in order to construct or expand the optical communication network 1A to preliminarily know that the multi-core fiber connected body is of a normal type. As a result, it is possible to carry out the connection operation only with knowledge concerning the connection destinations of the ports on the other end of the multi-core fiber connected body.

An additional characteristic of the optical communication network 1A is that the directions of the multi-core fiber connected bodies Cs1 to Cs5 are aligned so as to allow the coupling structures of the FI/FO devices connected to the end surfaces located on a downstream side of a flow following the ring-type network clockwise to coincide. In the example illustrated, the directions of the multi-core fiber connected bodies Cs1 to Cs5 are aligned so that all the FI/FO devices located on a downstream side of the flow following the ring-type network clockwise are the FI/FO devices τ2.

This enables an operator who connects one end of the multi-core fiber connected body to a node in order to construct or expand the optical communication network 1A to preliminarily know whether the FI/FO device at hand is the FI/FO device τ1 or the FI/FO device τ2, as well as know that the multi-core fiber connected body is of a normal type. This makes it possible to more easily carry out the connection operation.

### Second Specific Example

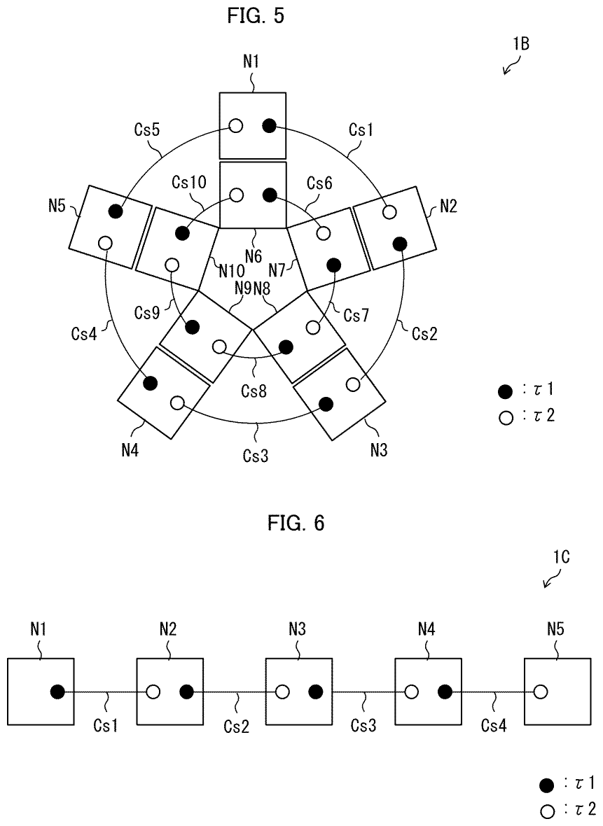

With reference to FIG. 5, the following description will discuss a second specific example of an optical communication network in accordance with the embodiment (hereinafter, referred to as “optical communication network 1B”).

The optical communication network 1B in accordance with the present specific example includes a plurality of nodes N1 to N10 and a plurality of multi-core fiber connected bodies Cs1 to Cs10 connecting the nodes. The nodes N1 to N5 and the multi-core fiber connected bodies Cs1 to Cs5 constitute a first ring-type network. Further, the nodes N6 to N10 and the multi-core fiber connected bodies Cs6 to Cs10 constitute a second ring-type network surrounded by the first ring-type network. That is, the nodes N1 to N10 and the multi-core fiber connected bodies Cs1 to Cs10 constitute a dual ring-type network. Each of the multi-core fiber connected bodies Cs1 to Cs10 is a normal-type multi-core fiber connected body.

A characteristic of the optical communication network 1B is that all of the transmission paths thereof connecting the nodes are constituted by normal-type multi-core fiber connected bodies, that is, multi-core fiber connected bodies in each of which the FI/FO devices having reversely symmetrical coupling structures are connected to the both ends of the multi-core fiber.

This enables an operator who connects one end of the multi-core fiber connected body to a node in order to construct or expand the optical communication network 1B to preliminarily know that the multi-core fiber connected body is of a normal type. As a result, it is possible to carry out the connection operation only with knowledge concerning the connection destinations of the ports on the other end of the multi-core fiber connected body.

Additional characteristics of the optical communication network 1B are that (1) the directions of the multi-core fiber connected bodies Cs1 to Cs5 are aligned so as to allow the coupling structures of the FI/FO devices located on a downstream side of a flow following the first ring-type network clockwise to coincide and (2) that the directions of the multi-core fiber connected bodies Cs6 to Cs10 are aligned so as to allow the FI/FO devices located on a downstream side of a flow following the second ring-type network clockwise to coincide. In the example illustrated, the directions of the multi-core fiber connected bodies Cs1 to Cs5 and the directions of the multi-core fiber connected bodies Cs6 to Cs10 are both aligned so that all the FI/FO devices located on downstream sides of the flows following the ring-type networks clockwise are the FI/FO devices τ2.

This enables an operator who connects one end of the multi-core fiber connected body to a node in order to construct or expand the optical communication network 1B to preliminarily know whether the FI/FO device at hand is the FI/FO device τ1 or the FI/FO device τ2, as well as know that the multi-core fiber connected body is of a normal type. This makes it possible to more easily carry out the connection operation.

Note that it is also possible that the directions of the multi-core fiber connected bodies Cs1 to Cs5 or the directions of the multi-core fiber connected bodies Cs6 to Cs10 may be aligned so that all the FI/FO devices located on a downstream side of the flow following the ring-type network clockwise are the FI/FO devices τ1. However, in this case, an operator who connects the one end of the multi-core fiber connected body to a node in order to construct or expand the optical communication network 1B needs to have knowledge on whether the network that the worker is handling is the first ring-type network or the second ring-type network.

### Third Specific Example

With reference to FIG. 6, the following description will discuss a third specific example of an optical communication network in accordance with the embodiment (hereinafter, referred to as “optical communication network 1C”).

The optical communication network 1C in accordance with the present specific example includes a plurality of nodes N1 to N5 and a plurality of multi-core fiber connected bodies Cs1 to Cs4 connecting the nodes. The nodes N1 to N5 and the multi-core fiber connected bodies Cs1 to Cs4 constitute a line-type network. Each of the multi-core fiber connected bodies Cs1 to Cs4 is a normal-type multi-core fiber connected body.

A characteristic of the optical communication network 1C is that all of the transmission paths thereof connecting the nodes are constituted by normal-type multi-core fiber connected bodies, that is, multi-core fiber connected bodies in each of which the FI/FO devices having reversely symmetrical coupling structures are connected to the both ends of the multi-core fiber.

This enables an operator who connects one end of the multi-core fiber connected body to a node in order to construct or expand the optical communication network 1C to preliminarily know that the multi-core fiber connected body is of a normal type. As a result, it is possible to carry out the connection operation only with knowledge concerning the connection destinations of the ports on the other end of the multi-core fiber connected body.

An additional characteristic of the optical communication network 1C is that the directions of the multi-core fiber connected bodies Cs1 to Cs4 are aligned so as to allow the coupling structures of the FI/FO devices located on a downstream side of a flow following the line-type network from one end thereof (the left end in FIG. 6) to the other end thereof (the right end in FIG. 6) to coincide. In the example illustrated, the directions of the multi-core fiber connected bodies Cs1 to Cs4 are aligned so that all the FI/FO devices located on a downstream side of the flow following the line-type network from one end thereof to the other end thereof are the FI/FO devices 12.

This enables an operator who connects one end of the multi-core fiber connected body to a node in order to construct or expand the optical communication network 1C to preliminarily know whether the FI/FO device at hand is the FI/FO device τ1 or the FI/FO device τ2, as well as know that the multi-core fiber connected body is of a normal type. This makes it possible to more easily carry out the connection operation.

### Fourth Specific Example

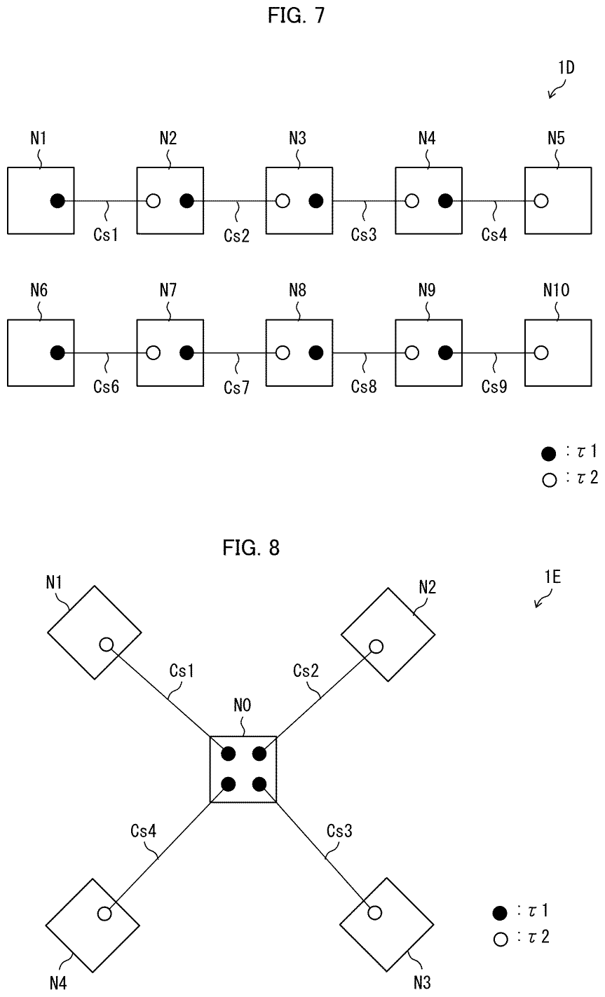

With reference to FIG. 7, the following description will discuss a fourth specific example of an optical communication network in accordance with the embodiment (hereinafter, referred to as “optical communication network 1D”).

The optical communication network 1D in accordance with the present specific example includes a plurality of nodes N1 to N10 and a plurality of multi-core fiber connected bodies Cs1 to Cs4 and Cs6 to Cs9 connecting the nodes. The nodes N1 to N5 and the multi-core fiber connected bodies Cs1 to Cs4 constitute a first line-type network. The nodes N6 to N10 and the multi-core fiber connected bodies Cs6 to Cs9 constitute a second line-type network running side by side parallel to the first line-type network. That is, the nodes N1 to N10 and the multi-core fiber connected bodies Cs1 to Cs4 and Cs6 to Cs9 constitute a dual line-type network. Each of the multi-core fiber connected bodies Cs1 to Cs4 and Cs6 to Cs9 is a normal-type multi-core fiber connected body.

A characteristic of the optical communication network 1D is that all of the transmission paths thereof connecting the nodes are constituted by normal-type multi-core fiber connected bodies, that is, multi-core fiber connected bodies in each of which the FI/FO devices having reversely symmetrical coupling structures are connected to the both ends of the multi-core fiber.

This enables an operator who connects one end of the multi-core fiber connected body to a node in order to construct or expand the optical communication network 1D to preliminarily know that the multi-core fiber connected body is of a normal type. As a result, it is possible to carry out the connection operation only with knowledge concerning the connection destinations of the ports on the other end of the multi-core fiber connected body.

Additional characteristics of the optical communication network 1D are (1) that the directions of the multi-core fiber connected bodies Cs1 to Cs4 are aligned so as to allow the coupling structures of the FI/FO devices located on a downstream side of a flow following the first line-type network from one end thereof (the left end in FIG. 6) to the other end thereof (the right end in FIG. 6) to coincide and (2) that the directions of the multi-core fiber connected bodies Cs6 to Cs9 are aligned so as to allow the coupling structures of the FI/FO devices located on a downstream side of a flow following the second line-type network from one end thereof (the left end in FIG. 6) to the other end thereof (the right end in FIG. 6) to coincide. In the example illustrated, the directions of the multi-core fiber connected bodies Cs1 to Cs4 and the directions of the multi-core fiber connected bodies Cs6 to Cs9 are both aligned so that all the FI/FO devices located on downstream sides of the flows following the line-type networks from the one ends thereof to the other ends thereof are the FI/FO devices τ2.

This enables an operator who connects one end of the multi-core fiber connected body to a node in order to construct or expand the optical communication network 1D to preliminarily know whether the FI/FO device at hand is the FI/FO device T1 or the FI/FO device τ2, as well as know that the multi-core fiber connected body is of a normal type. This makes it possible to more easily carry out the connection operation.

Note that it is also possible that the directions of the multi-core fiber connected bodies Cs1 to Cs4 or the directions of the multi-core fiber connected bodies Cs6 to Cs9 may be aligned so that all the end surfaces located on a downstream side of the flow following the line-type network from the one end thereof to the other end thereof are the end surfaces 1. However, in this case, an operator who connects the one end of the multi-core fiber connected body to a node in order to construct or expand the optical communication network 1D needs to have knowledge on whether the network that the worker is handling is the first line-type network or the second line-type network.

### Fifth Specific Example

With reference to FIG. 8, the following description will discuss a fifth specific example of an optical communication network in accordance with the embodiment (hereinafter, referred to as “optical communication network 1E”).

The optical communication network 1E in accordance with the present specific example includes a plurality of nodes N0 to N4 and a plurality of multi-core fiber connected bodies Cs1 to Cs4 connecting the nodes. The nodes N0 to N4 and the multi-core fiber connected bodies Cs1 to Cs4 constitute a star-type network including the node N0 as a center node. Each of the multi-core fiber connected bodies Cs1 to Cs4 is a normal-type multi-core fiber connected body.

A characteristic of the optical communication network 1E is that all of the transmission paths thereof connecting the nodes are constituted by normal-type multi-core fiber connected bodies, that is, multi-core fiber connected bodies in each of which the FI/FO devices having reversely symmetrical coupling structures are connected to the both ends of the multi-core fiber.

This enables an operator who connects one end of the multi-core fiber connected body to a node in order to construct or expand the optical communication network 1E to preliminarily know that the multi-core fiber connected body is of a normal type. As a result, it is possible to carry out the connection operation only with knowledge concerning the connection destinations of the ports on the other end of the multi-core fiber connected body.

An additional characteristic of the optical communication network 1E is that the directions of the multi-core fiber connected bodies Cs1 to Cs4 are aligned so as to allow the coupling structures of the FI/FO devices located on downstream sides of flows away from the center node (node N0) of the star-type network to coincide. In the example illustrated, the directions of the multi-core fiber connected bodies Cs1 to Cs4 are aligned so that all the FI/FO devices located on downstream sides of the flows away from the center node of the star-type network are the FI/FO devices τ2.

This enables an operator who connects one end of the multi-core fiber connected body to a node in order to construct or expand the optical communication network 1E to preliminarily know whether the FI/FO device at hand is the FI/FO device τ1 or the FI/FO device τ2, as well as know that the multi-core fiber connected body is of a normal type. This makes it possible to more easily carry out the connection operation.

### Sixth Specific Example

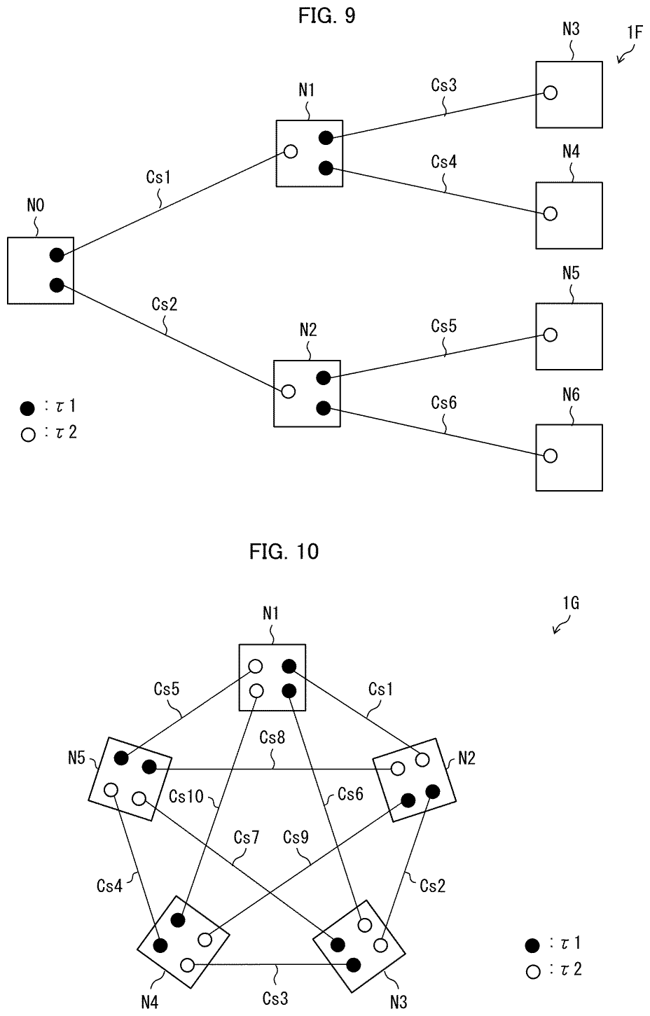

With reference to FIG. 9, the following description will discuss a sixth specific example of an optical communication network in accordance with the embodiment (hereinafter, referred to as “optical communication network 1F”).

The optical communication network 1F in accordance with the present specific example includes a plurality of nodes N0 to N6 and a plurality of multi-core fiber connected bodies Cs1 to Cs6 connecting the nodes. The nodes N0 to N6 and the multi-core fiber connected bodies Cs1 to Cs6 constitute a tree-type network including the node N0 as a root node. Each of the multi-core fiber connected bodies Cs1 to Cs6 is a normal-type multi-core fiber connected body.

A characteristic of the optical communication network 1F is that all of the transmission paths thereof connecting the nodes are constituted by normal-type multi-core fiber connected bodies, that is, multi-core fiber connected bodies in each of which the FI/FO devices having reversely symmetrical coupling structures are connected to the both ends of the multi-core fiber.

This enables an operator who connects one end of the multi-core fiber connected body to a node in order to construct or expand the optical communication network 1F to preliminarily know that the multi-core fiber connected body is of a normal type. As a result, it is possible to carry out the connection operation only with knowledge concerning the connection destinations of the ports on the other end of the multi-core fiber connected body.

An additional characteristic of the optical communication network 1F is that the directions of the multi-core fiber connected bodies Cs1 to Cs6 are aligned so as to allow the coupling structures of the FI/FO devices located on downstream sides of flows away from the root node (node N0) of the tree-type network to coincide. In the example illustrated, the directions of the multi-core fiber connected bodies Cs1 to Cs6 are aligned so that all the FI/FO devices located on downstream sides of the flows away from the root node of the tree-type network are the FI/FO devices 12.

This enables an operator who connects one end of the multi-core fiber connected body to a node in order to construct or expand the optical communication network 1F to preliminarily know whether the FI/FO device at hand is the FI/FO device τ1 or the FI/FO device τ2, as well as know that the multi-core fiber connected body is of a normal type. This makes it possible to more easily carry out the connection operation.

### Seventh Specific Example

With reference to FIG. 10, the following description will discuss a seventh specific example of an optical communication network in accordance with the embodiment (hereinafter, referred to as “optical communication network 1G”).

The optical communication network 1G in accordance with the present specific example includes a plurality of nodes N1 to N5 and a plurality of multi-core fiber connected bodies Cs1 to Cs10 connecting the nodes. The nodes N1 to N5 and the multi-core fiber connected bodies Cs1 to Cs10 constitute a fully connected-type network. Each of the multi-core fiber connected bodies Cs1 to Cs6 is a normal-type multi-core fiber connected body.

A characteristic of the optical communication network 1G is that all of the transmission paths thereof connecting the nodes are constituted by normal-type multi-core fiber connected bodies, that is, multi-core fiber connected bodies in each of which the FI/FO devices having reversely symmetrical coupling structures are connected to the both ends of the multi-core fiber.

This enables an operator who connects one end of the multi-core fiber connected body to a node in order to construct or expand the optical communication network 1G to preliminarily know that the multi-core fiber connected body is of a normal type. As a result, it is possible to carry out the connection operation only with knowledge concerning the connection destinations of the ports on the other end of the multi-core fiber connected body.

### Eighth Specific Example

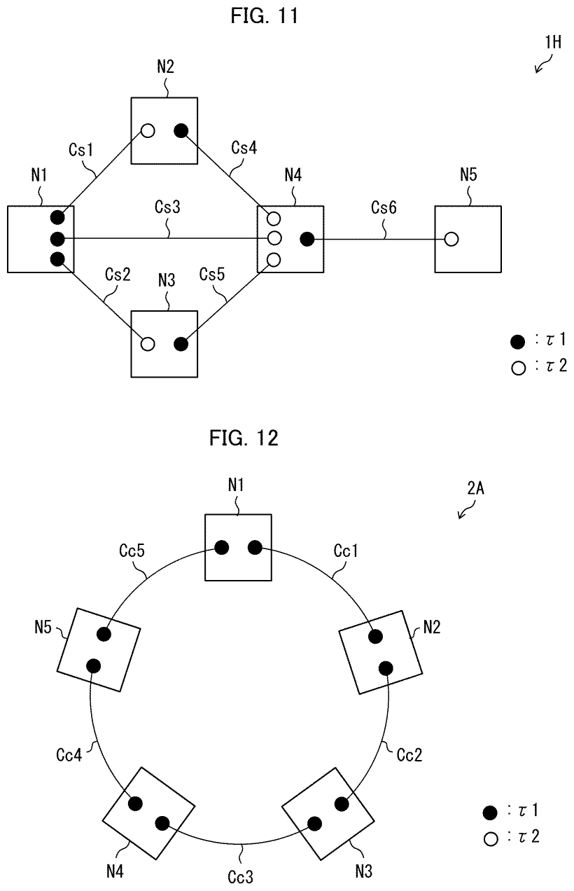

With reference to FIG. 11, the following description will discuss an eighth specific example of an optical communication network in accordance with the embodiment (hereinafter, referred to as “optical communication network 1H”).

The optical communication network 1H in accordance with the present specific example includes a plurality of nodes N1 to N5 and a plurality of multi-core fiber connected bodies Cs1 to Cs6 connecting the nodes. The nodes N1 to N5 and the multi-core fiber connected bodies Cs1 to Cs6 constitute a mesh-type network. Each of the multi-core fiber connected bodies Cs1 to Cs6 is a normal-type multi-core fiber connected body.

A characteristic of the optical communication network 1H is that all of the transmission paths thereof connecting the nodes are constituted by normal-type multi-core fiber connected bodies, that is, multi-core fiber connected bodies in each of which the FI/FO devices having reversely symmetrical coupling structures are connected to the both ends of the multi-core fiber.

This enables an operator who connects one end of the multi-core fiber connected body to a node in order to construct or expand the optical communication network 1H to preliminarily know that the multi-core fiber connected body is of a normal type. As a result, it is possible to carry out the connection operation only with knowledge concerning the connection destinations of the ports on the other end of the multi-core fiber connected body.

### Embodiment 2

With reference to FIGS. 12 to 19, the following description will discuss optical communication networks 2A to 2H in accordance with Embodiment 2 of the present invention. The optical communication networks 2A to 2H in accordance with the embodiment are each an optical communication network including a plurality of nodes and including a domain in which all of a plurality of transmission paths that connect nodes within the domain are constituted by multi-core fiber connected bodies (reverse-type multi-core fiber connected bodies) in which FI/FO devices having congruent coupling structures are connected to both ends of a multi-core fiber.

### First Specific Example

With reference to FIG. 12, the following description will discuss a first specific example of an optical communication network in accordance with the embodiment (hereinafter, referred to as “optical communication network 2A”).

The optical communication network 2A in accordance with the present specific example includes a plurality of nodes N1 to N5 and a plurality of multi-core fiber connected bodies Cc1 to Cc5 connecting the nodes. The nodes N1 to N5 and the multi-core fiber connected bodies Cc1 to Cc5 constitute a ring-type network. Each of the multi-core fiber connected bodies Cc1 to Cc5 is a reverse-type multi-core fiber connected body.

A characteristic of the optical communication network 2A is that all of the transmission paths thereof connecting the nodes are constituted by reverse-type multi-core fiber connected bodies, that is, multi-core fiber connected bodies in each of which the FI/FO devices having congruent coupling structures are connected to the both ends of the multi-core fiber.

This enables an operator who connects one end of the multi-core fiber connected body to a node in order to construct or expand the optical communication network 2A to preliminarily know that the multi-core fiber connected body is of a reverse type. As a result, it is possible to carry out the connection operation only with knowledge concerning the connection destinations of the ports on the other end of the multi-core fiber connected body.

### Second Specific Example

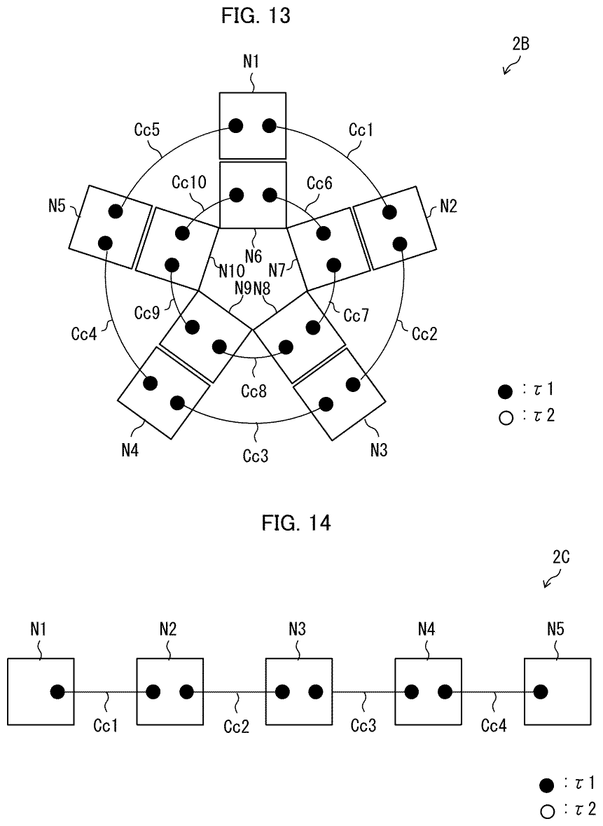

With reference to FIG. 13, the following description will discuss a second specific example of an optical communication network in accordance with the embodiment (hereinafter, referred to as “optical communication network 2B”).

The optical communication network 2B in accordance with the present specific example includes a plurality of nodes N1 to N10 and a plurality of multi-core fiber connected bodies Cc1 to Cc10 connecting the nodes. The nodes N1 to N5 and the multi-core fiber connected bodies Cc1 to Cc5 constitute a first ring-type network. Further, the nodes N6 to N10 and the multi-core fiber connected bodies Cc6 to Cc10 constitute a second ring-type network surrounded by the first ring-type network. That is, the nodes N1 to N10 and the multi-core fiber connected bodies Cc1 to Cc10 constitute a dual ring-type network. Each of the multi-core fiber connected bodies Cc1 to Cc10 is a reverse-type multi-core fiber connected body.

A characteristic of the optical communication network 2B is that all of the transmission paths thereof connecting the nodes are constituted by reverse-type multi-core fiber connected bodies, that is, multi-core fiber connected bodies in each of which the FI/FO devices having congruent coupling structures are connected to the both ends of the multi-core fiber.

This enables an operator who connects one end of the multi-core fiber connected body to a node in order to construct or expand the optical communication network 2B to preliminarily know that the multi-core fiber connected body is of a reverse-type. As a result, it is possible to carry out the connection operation only with knowledge concerning the connection destinations of the ports on the other end of the multi-core fiber connected body.

### Third Specific Example

With reference to FIG. 14, the following description will discuss a third specific example of an optical communication network in accordance with the embodiment (hereinafter, referred to as “optical communication network 2C”).

The optical communication network 2C in accordance with the present specific example includes a plurality of nodes N1 to N5 and a plurality of multi-core fiber connected bodies Cc1 to Cc4 connecting the nodes. The nodes N1 to N5 and the multi-core fiber connected bodies Cc1 to Cc4 constitute a line-type network. Each of the multi-core fiber connected bodies Cc1 to Cc4 is a reverse-type multi-core fiber connected body.

A characteristic of the optical communication network 2C is that all of the transmission paths thereof connecting the nodes are constituted by reverse-type multi-core fiber connected bodies, that is, multi-core fiber connected bodies in each of which the FI/FO devices having congruent coupling structures are connected to the both ends of the multi-core fiber.

This enables an operator who connects one end of the multi-core fiber connected body to a node in order to construct or expand the optical communication network 2C to preliminarily know that the multi-core fiber connected body is of a reverse type. As a result, it is possible to carry out the connection operation only with knowledge concerning the connection destinations of the ports on the other end of the multi-core fiber connected body.

### Fourth Specific Example

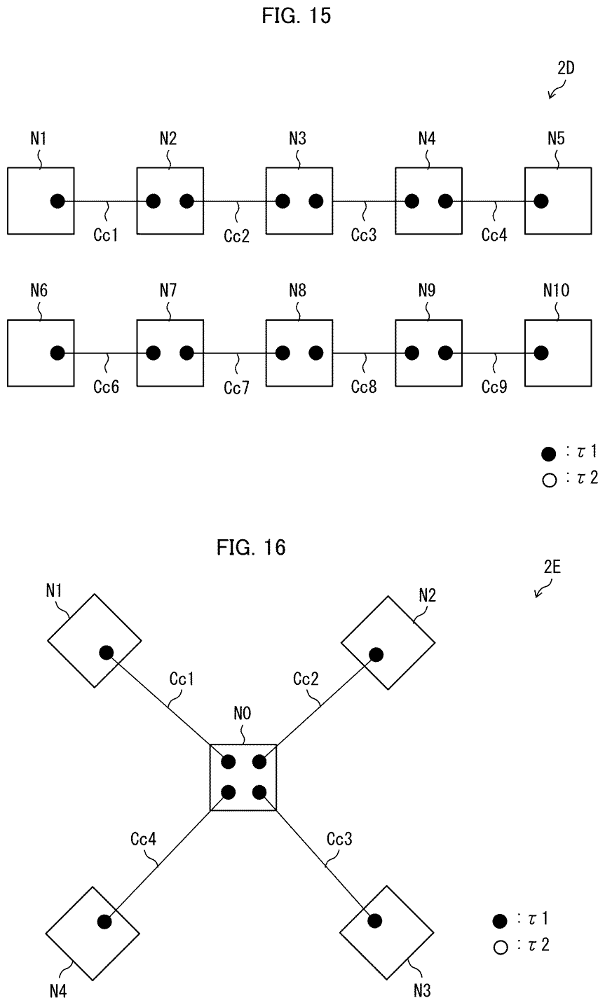

With reference to FIG. 15, the following description will discuss a fourth specific example of an optical communication network in accordance with the embodiment (hereinafter, referred to as “optical communication network 2D”).

The optical communication network 2D in accordance with the present specific example includes a plurality of nodes N1 to N10 and a plurality of multi-core fiber connected bodies Cc1 to Cc4 and Cc6 to Cc9 connecting the nodes. The nodes N1 to N5 and the multi-core fiber connected bodies Cc1 to Cc4 constitute a first line-type network. The nodes N6 to N10 and the multi-core fiber connected bodies Cc6 to Cc9 constitute a second line-type network running side by side parallel to the first line-type network. That is, the nodes N1 to N10 and the multi-core fiber connected bodies Cc1 to Cc4 and Cc6 to Cc9 constitute a dual line-type network. Each of the multi-core fiber connected bodies Cc1 to Cc4 and Cc6 to Cc9 is a reverse-type multi-core fiber connected body.

A characteristic of the optical communication network 2D is that all of the transmission paths thereof connecting the nodes are constituted by reverse-type multi-core fiber connected bodies, that is, multi-core fiber connected bodies in each of which the FI/FO devices having congruent coupling structures are connected to the both ends of the multi-core fiber.

This enables an operator who connects one end of the multi-core fiber connected body to a node in order to construct or expand the optical communication network 2D to preliminarily know that the multi-core fiber connected body is of a reverse type. As a result, it is possible to carry out the connection operation only with knowledge concerning the connection destinations of the ports on the other end of the multi-core fiber connected body.

### Fifth Specific Example

With reference to FIG. 16, the following description will discuss a fifth specific example of an optical communication network in accordance with the embodiment (hereinafter, referred to as “optical communication network 2E”).

The optical communication network 2E in accordance with the present specific example includes a plurality of nodes N0 to N4 and a plurality of multi-core fiber connected bodies Cc1 to Cc4 connecting the nodes. The nodes N0 to N4 and the multi-core fiber connected bodies Cc1 to Cc4 constitute a star-type network including the node N0 as a center node. Each of the multi-core fiber connected bodies Cc1 to Cc4 is a reverse-type multi-core fiber connected body.

A characteristic of the optical communication network 2E is that all of the transmission paths thereof connecting the nodes are constituted by reverse-type multi-core fiber connected bodies, that is, multi-core fiber connected bodies in each of which the FI/FO devices having congruent coupling structures are connected to the both ends of the multi-core fiber.

This enables an operator who connects one end of the multi-core fiber connected body to a node in order to construct or expand the optical communication network 2E to preliminarily know that the multi-core fiber connected body is of a reverse type. As a result, it is possible to carry out the connection operation only with knowledge concerning the connection destinations of the ports on the other end of the multi-core fiber connected body.

### Sixth Specific Example

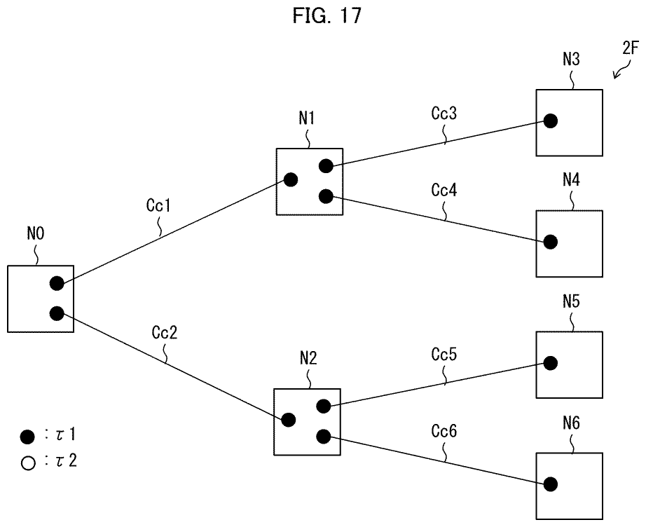

With reference to FIG. 17, the following description will discuss a sixth specific example of an optical communication network in accordance with the embodiment (hereinafter, referred to as “optical communication network 2F”).

The optical communication network 2F in accordance with the present specific example includes a plurality of nodes N0 to N6 and a plurality of multi-core fiber connected bodies Cc1 to Cc6 connecting the nodes. The nodes N0 to N6 and the multi-core fiber connected bodies Cc1 to Cc6 constitute a tree-type network including the node N0 as a root node. Each of the multi-core fiber connected bodies Cc1 to Cc6 is a reverse-type multi-core fiber connected body.

A characteristic of the optical communication network 2F is that all of the transmission paths thereof connecting the nodes are constituted by reverse-type multi-core fiber connected bodies, that is, multi-core fiber connected bodies in each of which the FI/FO devices having congruent coupling structures are connected to the both ends of the multi-core fiber.

This enables an operator who connects one end of the multi-core fiber connected body to a node in order to construct or expand the optical communication network 2F to preliminarily know that the multi-core fiber connected body is of a reverse type. As a result, it is possible to carry out the connection operation only with knowledge concerning the connection destinations of the ports on the other end of the multi-core fiber connected body.

### Seventh Specific Example

With reference to FIG. 18, the following description will discuss a seventh specific example of an optical communication network in accordance with the embodiment (hereinafter, referred to as “optical communication network 2G”).

The optical communication network 2G in accordance with the present specific example includes a plurality of nodes N1 to N5 and a plurality of multi-core fiber connected bodies Cc1 to Cc10 connecting the nodes. The nodes N1 to N5 and the multi-core fiber connected bodies Cc1 to Cc10 constitute a fully connected-type network. Each of the multi-core fiber connected bodies Cc1 to Cc6 is a reverse-type multi-core fiber connected body.

A characteristic of the optical communication network 2G is that all of the transmission paths thereof connecting the nodes are constituted by reverse-type multi-core fiber connected bodies, that is, multi-core fiber connected bodies in each of which the FI/FO devices having congruent coupling structures are connected to the both ends of the multi-core fiber.

This enables an operator who connects one end of the multi-core fiber connected body to a node in order to construct or expand the optical communication network 2G to preliminarily know that the multi-core fiber connected body is of a reverse type. As a result, it is possible to carry out the connection operation only with knowledge concerning the connection destinations of the ports on the other end of the multi-core fiber connected body.

### Eighth Specific Example

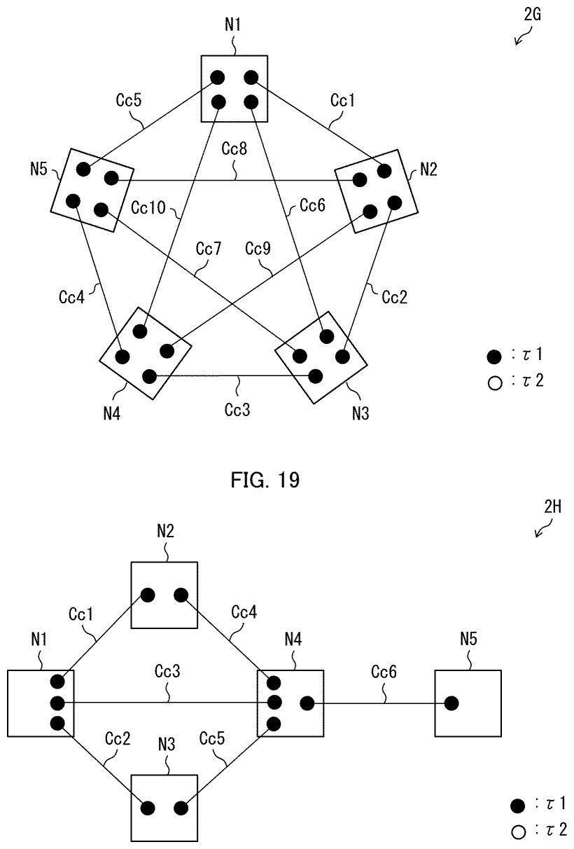

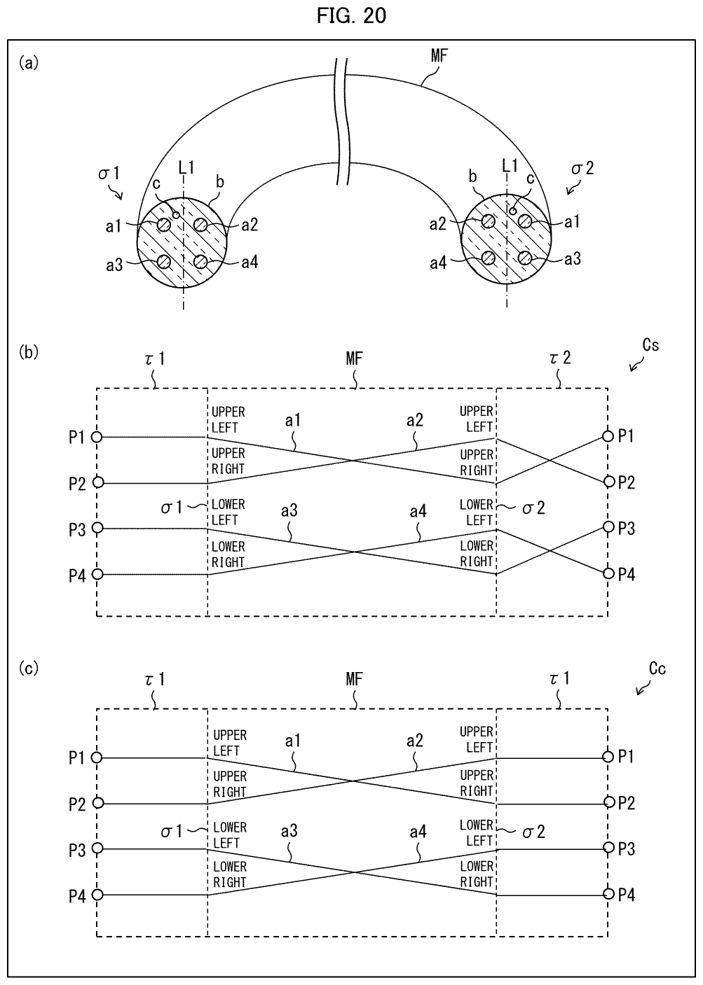

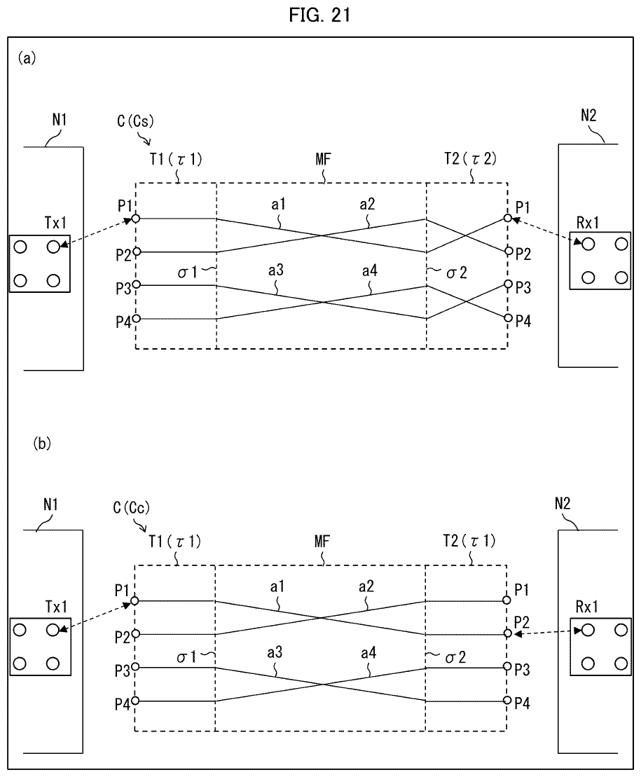

With reference to FIG. 19, the following description will discuss an eighth specific example of an optical communication network in accordance with the embodiment (hereinafter, referred to as “optical communication network 2H”).

The optical communication network 2H in accordance with the present specific example includes a plurality of nodes N1 to N5 and a plurality of multi-core fiber connected bodies Cc1 to Cc6 connecting the nodes. The nodes N1 to N5 and the multi-core fiber connected bodies Cc1 to Cc6 constitute a mesh-type network. Each of the multi-core fiber connected bodies Cc1 to Cc6 is a reverse-type multi-core fiber connected body.

A characteristic of the optical communication network 2H is that all of the transmission paths thereof connecting the nodes are constituted by reverse-type multi-core fiber connected bodies, that is, multi-core fiber connected bodies in each of which the FI/FO devices having congruent coupling structures are connected to the both ends of the multi-core fiber.

This enables an operator who connects one end of the multi-core fiber connected body to a node in order to construct or expand the optical communication network 2H to preliminarily know that the multi-core fiber connected body is of a reverse type. As a result, it is possible to carry out the connection operation only with knowledge concerning the connection destinations of the ports on the other end of the multi-core fiber connected body.

Aspects of the present invention can also be expressed as follows:

An optical communication network in accordance with Aspect 1 of the present invention is an optical communication network including a plurality of nodes, the optical communication network including: (1) a domain in which all of a plurality of transmission paths that connect nodes within the domain are constituted by multi-core fiber connected bodies each of which includes one or more multi-core fibers and paired FI/FO devices connected to both ends of the one or more multi-core fibers and having reversely symmetrical coupling structures or (2) a domain in which all of a plurality of transmission paths that connect nodes within the domain are constituted by multi-core fiber connected bodies each of which includes one or more multi-core fibers and paired FI/FO devices connected to both ends of the one or more multi-core fibers and having congruent coupling structures, the paired FI/FO devices each having ports identifiable from each other, the ports being coupled with respective cores of the one or more multi-core fibers.

An optical communication network in accordance with Aspect 2 of the present invention is configured, in the optical communication network in accordance with Aspect 1, such that all of the plurality of transmission paths are constituted by the multi-core fiber connected bodies each of which includes the one or more multi-core fibers and the paired FI/FO devices connected to the both ends of the one or more multi-core fibers and having reversely symmetrical coupling structures.

An optical communication network in accordance with Aspect 3 of the present invention is configured, in the optical communication network in accordance with Aspect 2, such that the plurality of nodes and the plurality of transmission paths constitute a ring-type network, and
directions of the one or more multi-core fibers or the multi-core fiber connected bodies constituting the plurality of transmission paths are aligned so as to allow coupling structures of FI/FO devices located on a downstream side of a flow following the ring-type network clockwise to coincide.

An optical communication network in accordance with Aspect 4 of the present invention is configured, in the optical communication network in accordance with Aspect 2, such that the plurality of nodes and the plurality of transmission paths constitute a line-type network, and directions of the one or more multi-core fibers or the multi-core fiber connected bodies constituting the plurality of transmission paths are aligned so as to allow coupling structures of FI/FO devices located on a downstream side of a flow following the line-type network from one end to the other end of the line-type network to coincide.

An optical communication network in accordance with Aspect 5 of the present invention is configured, in the optical communication network in accordance with Aspect 2, such that the plurality of nodes and the plurality of transmission paths constitute a star-type network, and directions of the one or more multi-core fibers or the multi-core fiber connected bodies constituting the plurality of transmission paths are aligned so as to allow coupling structures of FI/FO devices located on downstream sides of flows away from a center node of the star-type network to coincide.

An optical communication network in accordance with Aspect 6 of the present invention is configured, in the optical communication network in accordance with Aspect 2, such that the plurality of nodes and the plurality of transmission paths constitute a tree-type network, and directions of the one or more multi-core fibers or the multi-core fiber connected bodies constituting the plurality of transmission paths are aligned so as to allow coupling structures of FI/FO devices located on a downstream side of a flow away from a root of the tree-type network to coincide.

An optical communication network in accordance with Aspect 7 of the present invention is configured, in the optical communication network in accordance with Aspect 2, such that the plurality of nodes and the plurality of transmission paths constitute a fully connected-type network or a mesh-type network.

An optical communication network in accordance with Aspect 8 of the present invention is configured, in the optical communication network in accordance with Aspect 1, such that all of the plurality of transmission paths are constituted by the multi-core fiber connected bodies each of which includes the one or more multi-core fibers and the paired FI/FO devices connected to the both ends of the one or more multi-core fibers and having congruent coupling structures.

A multi-core fiber connected body in accordance with Aspect 9 of the present invention includes: one or more multi-core fibers; and paired FI/FO devices connected to both ends of the one or more multi-core fibers, the paired FI/FO devices having reversely symmetrical coupling structures or having congruent coupling structures, the paired FI/FO devices each having ports identifiable from each other, the ports being coupled with respective cores of the one or more multi-core fibers.

A multi-core fiber connected body in accordance with Aspect 10 of the present invention is configured, in the multi-core fiber connected body in accordance with Aspect 9, such that the paired FI/FO devices are identifiable from each other in view of a color of a surface of a single-core fiber connected to an end portion opposite to an end portion of each of the paired FI/FO devices which is connected to the one or more multi-core fibers, a color of a surface of a housing of each of the paired FI/FO devices, a character printed on the surface of the single-core fiber or printed on the surface of the housing, a shape of the housing, or a label attached to the single-core fiber.

A multi-core fiber in accordance with Aspect 11 of the present invention is configured, in the multi-core fiber connected body in accordance with Aspect 9 or 10, such that the one or more multi-core fibers are each a multi-core fiber with no marker or a multi-core fiber which includes a cladding, a marker, and the cores disposed so as to be axisymmetric with respect to an imaginary symmetrical axis passing a center of the cladding in cross-sectional view of the cladding and in which a center of the marker is disposed on the imaginary symmetrical axis.

A method for manufacturing an optical communication network, in accordance with Aspect 12 of the present invention is a method for manufacturing an optical communication network including a plurality of nodes, the method including the step of, as all of a plurality of transmission paths connecting nodes within a specific domain, (1) selecting multi-core fiber connected bodies each of which includes a multi-core fiber and paired FI/FO devices connected to both ends of the multi-core fiber and having reversely symmetrical coupling structures or (2) selecting multi-core fiber connected bodies each of which includes a multi-core fiber and paired FI/FO devices connected to both ends of the multi-core fiber and having congruent coupling structures, the paired FI/FO devices each having ports identifiable from each other, the ports being coupled with cores of the multi-core fiber.

### Supplementary Remarks

The present invention is not limited to the foregoing embodiments, but can be modified by a person skilled in the art within the scope of the claims. The present invention also encompasses, in its technical scope, any embodiments derived by combining technical means disclosed in the foregoing embodiments.

For example, the number of the nodes in accordance with the above-described embodiments may be two or three or more. In a case where the number of the nodes is not less than three, a plurality of transmission paths between the nodes are present. This increases the degree of freedom in selection of the normal-type or reverse-type multi-core fiber connected bodies between all the nodes. Thus, the operation of connecting the multi-core fiber connected bodies to the nodes by the operator and the configuration of the optical communication network become complicated. Especially in such a case, applying the multi-core fiber connected bodies in accordance with the above-described embodiments to the optical communication network may further facilitate construction or design of the optical communication network or, the connection operation for increasing or decreasing the number of nodes.

The multi-core fiber connected body in accordance with one or more embodiments is configured to include: one or more multi-core fibers; and paired FI/FO devices connected to both ends of the one or more multi-core fibers, the paired FI/FO devices having reversely symmetrical coupling structures or having congruent coupling structures, the paired FI/FO devices each having ports identifiable from each other, the ports being coupled with respective cores of the one or more multi-core fibers.

In a case of such a configuration of the multi-core fiber connected body, the FI/FO devices each have the ports identifiable from each other, the ports being coupled with the respective cores of the multi-core fiber. This makes it possible to identify two types of FI/FO devices having different coupling structures from each other. This enables identification of whether the paired FI/FO devices described above have reversely symmetrical coupling structures or congruent coupling structures. Therefore, applying the multi-core fiber connected bodies in accordance with the above-described embodiments to the optical communication network may further facilitate construction or design of the optical communication network or, the connection operation for increasing or decreasing the number of nodes.

The paired FI/FO devices in accordance with the above-described embodiments are identifiable from each other, for example, in view of a color of a surface of a single-core fiber connected to an end portion opposite to an end portion of each of the FI/FO devices which is connected to the multi-core fiber, a color of a surface of a housing of each of the FI/FO devices, a character printed on the surface of the single-core fiber or printed on the surface of the housing, a shape of the housing, or a label attached to the single-core fiber.

In a case of such a configuration of the multi-core fiber connected body, it is possible to identify two types of FI/FO devices from each other. This enables identification of whether the paired FI/FO devices described above have reversely symmetrical coupling structures or congruent coupling structures. Therefore, applying the multi-core fiber connected bodies in accordance with the above-described embodiments to the optical communication network may further facilitate construction or design of the optical communication network or, the connection operation for increasing or decreasing the number of nodes.

Here, realizable specific configurations of the color of the surface of the housing, the character, the shape of the housing, and the label which are described above are not particularly limited, provided that the paired FI/FO devices are identifiable from each other. For example, colors, characters, housing shapes, and labels having different characteristics from each other may be used. The colors may differ from each other by different shades or color combinations. The characters may differ from each other by different systems of writing and fonts. The label may be different numbers, symbols, or characters with different systems of writing or fonts.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

MF, MF1, M2, . . . . Multi-core fiber
Cs, Cs1, Cs2, . . . . Multi-core fiber connected body (normal type)
Cc, Cc1, Cc2, . . . . Multi-core fiber connected body (reverse type)
N0, N1, N2, . . . . Node
1A, 1B, . . . , 1H Optical communication network
2A, 2B, . . . , 2H Optical communication network

1.-12. (canceled)

13. An optical communication network comprising:
nodes; and
a domain in which all of transmission paths that connect the nodes within the domain are constituted by multi-core fiber connected bodies, each of which comprises one or more multi-core fibers and one or more pairs of Fan-In/Fan-Out (FI/FO) devices respectively connected to ends of a corresponding one of the one or more multi-core fibers, wherein
each pair of the one or more pairs of FI/FO devices connected to ends of the corresponding one of the one or more multi-core fibers has a reversely symmetrical coupling structure,
each of the one or more pairs of FI/FO devices comprises ports identifiable from each other and coupled with respective cores of the one or more multi-core fibers.

14. The optical communication network according to claim 13, wherein
the nodes and the transmission paths constitute a ring-type network, and
directions of the one or more multi-core fibers or the multi-core fiber connected bodies constituting the transmission paths are aligned such that coupling structures of those of the one or more pairs of FI/FO devices disposed on a downstream side of a flow following the ring-type network clockwise coincide.

15. The optical communication network according to claim 13, wherein
the nodes and the transmission paths constitute a line-type network, and
directions of the one or more multi-core fibers or the multi-core fiber connected bodies constituting the transmission paths are aligned such that coupling structures of those of the one or more pairs of FI/FO devices disposed on a downstream side of a flow following the line-type network from a first end to a second end of the line-type network coincide.

16. The optical communication network according to claim 13, wherein
the nodes and the transmission paths constitute a star-type network, and
directions of the one or more multi-core fibers or the multi-core fiber connected bodies constituting the transmission paths are aligned such that coupling structures of those of the one or more pairs of FI/FO devices disposed on downstream sides of flows away from a center node of the star-type network coincide.

17. The optical communication network according to claim 13, wherein
the nodes and the transmission paths constitute a tree-type network, and
directions of the one or more multi-core fibers or the multi-core fiber connected bodies constituting the transmission paths are aligned such that coupling structures of those of the one or more pairs of FI/FO devices disposed on a downstream side of a flow away from a root of the tree-type network coincide.

18. The optical communication network according to claim 13, wherein the nodes and the transmission paths constitute a fully connected-type network or a mesh-type network.

19. An optical communication network comprising:
nodes; and
a domain in which all of transmission paths that connect the nodes within the domain are constituted by multi-core fiber connected bodies, each of which comprises one or more multi-core fibers and one or more pairs of Fan-In/Fan-Out (FI/FO) devices respectively connected to ends of a corresponding one of the one or more multi-core fibers, wherein
each pair of the one or more pairs of FI/FO devices connected to ends of the corresponding one of the one or more multi-core fibers has a congruent coupling structure,
each of the one or more pairs of FI/FO devices comprises ports identifiable from each other and coupled with respective cores of the one or more multi-core fibers.

20. A multi-core fiber connected body comprising:
one or more multi-core fibers; and
one or more pairs of Fan-In/Fan-Out (FI/FO) devices respectively connected to ends of a corresponding one of the one or more multi-core fibers, wherein
each pair of the one or more pairs of FI/FO devices connected to ends of the corresponding one of the one or more multi-core fibers has either of:
a reversely symmetrical coupling structure, or
a congruent coupling structures,
each of the one or more pairs of FI/FO devices comprises ports identifiable from each other and coupled with respective cores of the one or more multi-core fibers.

21. The multi-core fiber connected body according to claim 20, wherein the one or more pairs of FI/FO devices are identifiable from each other in view of one or more of:
a color of a surface of a single-core fiber connected to an end portion opposite to an end portion of each of the one or more pairs of FI/FO devices connected to the one or more multi-core fibers,
a color of a surface of a housing of each of the one or more pairs of FI/FO devices,
a character printed on the surface of the single-core fiber or printed on the surface of the housing,
a shape of the housing, and
a label attached to the single-core fiber.

22. The multi-core fiber connected body according to claim 20, wherein each of the one or more multi-core fibers is either of:
a multi-core fiber with no marker, or
a multi-core fiber:
that comprises:
a cladding;
a marker; and
cores disposed axisymmetric with respect to an imaginary symmetrical axis passing a center of the cladding in a cross-sectional view of the cladding, and
in which a center of the marker is disposed on the imaginary symmetrical axis.

23. A method for manufacturing the optical communication network according to claim 13, the method comprising:
selecting the multi-core fiber connected bodies as all of the transmission paths connecting the nodes in the domain.

24. A method for manufacturing the optical communication network according to claim 19, the method comprising:
selecting the multi-core fiber connected bodies as all of the transmission paths connecting the nodes in the domain.
